(19) United States
(12) Patent Application Publication
(10) Pub. No.: US 2025/0034458 A1
(43) Pub. Date: Jan. 30, 2025

(54) INTEGRATION OF STEAM CRACKER AND BLUE AMMONIA UNITS TO REDUCE CO2 EMISSION

(71) Applicants: Rian Reyneke, Katy, TX (US); Paul Richard Langston, Middlesex (GB); John Lewis Webb, JR., Richmond, TX (US); Umesh Jain, Richmond, TX (US)

(72) Inventors: Rian Reyneke, Katy, TX (US); Paul Richard Langston, Middlesex (GB); John Lewis Webb, JR., Richmond, TX (US); Umesh Jain, Richmond, TX (US)

(73) Assignee: KELLOGG BROWN & ROOT LLC, Houston, TX (US)

(21) Appl. No.: 18/783,308

(22) Filed: Jul. 24, 2024

Related U.S. Application Data
(60) Provisional application No. 63/515,293, filed on Jul. 24, 2023.
(60) Provisional application No. 63/581,581, filed on Sep. 8, 2023.

(51) Int. Cl. C10G 9/36; C01B 3/04; C01C 1/02

(52) U.S. Cl. CPC C10G 9/36; C01B 3/047; C01C 1/024; C10G 2300/42; C10G 2400/20

(57) ABSTRACT

A process and system to integrate a steam cracking unit with a blue ammonia unit such that a methane-rich gas stream and/or a hydrogen-rich gas stream is directed from the steam cracking unit to the blue ammonia unit while a hydrogen gas containing stream is directed from the blue ammonia unit to the steam cracking unit.

This application claims the benefit of U.S. Provisional Application No. 63/515,293, filed Jul. 24, 2023, and U.S. Provisional Application No. 63/581,581, filed Sep. 8, 2023, both of which are incorporated herein by reference in their entirety.

### FIELD OF THE INVENTION

The present invention relates to a system and method for integration of steam cracker and Blue Ammonia units to reduce CO2 emission.

### BACKGROUND

Olefin production generally involves steam cracking, a process that can be very energy intensive and contributes substantially to global CO2 emissions. The primary source of direct CO2 emission is the cracking furnaces, where fuel gas is burned to provide the heat required for net process heating, to satisfy the cracking heat of reaction (endothermic reaction) and where waste heat is used to generate steam.

Fuel gas used in steam cracking units can contain as high as 80-85 mol % H2 in ethane crackers, or as low as 10-15 mol % in liquid crackers, with the remainder being mostly methane. Combustion of hydrogen has no associated CO2 emission, while combustion of methane produced approximately 230 kg CO2/Gcal of fired duty.

In typical steam cracking units, combustion air enters the furnace without being preheated. With cold combustion air, a substantial portion of the fired duty is required simply to heat up the combustion air to combustion temperature, with associated CO2 emissions. This produces a relatively large flue gas stream that is then used to provide the net heat for feed preheat and superheated high pressure (SHP) steam generation.

### SUMMARY OF THE INVENTION

Exemplary embodiments of an integration of steam cracking unit and blue hydrogen units to reduce CO2 emission that can substantially obviates one or more of the problems due to limitations and disadvantages of the related art.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

In examples, a system may include a steam cracking unit comprising a cracking furnace; a blue ammonia unit in fluid communication with the steam cracking unit, the blue ammonia unit configured to generate a hydrogen gas containing stream; a first conduit configured to direct the hydrogen gas containing stream to the steam cracking unit to be used as fuel.

In examples, the blue ammonia unit may include a hydrogen generation system configured to generate a hydrogen-rich ammonia syngas stream, wherein the hydrogen gas containing stream may include the hydrogen-rich ammonia syngas stream.

In examples, the blue ammonia unit may include an ammonia syngas purification system configured to generate a purified ammonia syngas stream, wherein the hydrogen gas containing stream may include the purified ammonia syngas stream.

In examples, the steam cracking unit may include a recovery system configured to receive an effluent cracked gas from the cracking furnace and separate from the effluent cracked gas at least a hydrogen-rich gas stream and a methane-rich gas stream.

In examples, the system may include a second conduit configured to direct the methane-rich gas stream from the steam cracking unit to the blue ammonia unit to be used as fuel, feed, or both.

In examples, the system may include a gas compressor configured to pressurize at least a portion of the methane-rich gas stream prior to reaching the blue ammonia unit.

In examples, the system may include a gas expander configured to expand the hydrogen gas containing stream prior to reaching the steam cracking unit.

In examples, the gas compressor may be powered by energy recovered by the gas expander.

In examples, the system may include a heater configured to heat the hydrogen gas containing stream prior to reaching the gas expander.

In examples, the steam cracking unit may include a recycle line configured to direct the hydrogen-rich gas stream from the recovery system to the cracking furnace to be used as fuel.

In examples, the blue ammonia unit may include a hydrogen generation system configured to generate a hydrogen-rich ammonia syngas stream, wherein the hydrogen gas containing stream may include the hydrogen-rich ammonia syngas stream; and a fourth conduit configured to direct at least a portion of the hydrogen-rich ammonia syngas stream to the steam cracking unit for combination with the hydrogen-rich gas stream.

In examples, the blue ammonia unit may include an ammonia syngas purification system configured to generate a purified ammonia syngas stream, wherein the hydrogen gas containing stream may include the purified ammonia syngas stream; and a fourth conduit configured to direct at least a portion of the purified ammonia syngas stream to the steam cracking unit for combination with the hydrogen-rich gas stream.

In examples, the system may include a third conduit configured to direct at least a portion of the hydrogen-rich gas stream from the steam cracking unit to the blue ammonia unit.

In examples, the blue ammonia unit may include an ammonia syngas purification system, wherein the whole hydrogen-rich gas stream may be directed to the ammonia syngas purification system.

In examples, the system may include a fourth conduit configured to direct an effluent purified ammonia syngas from the ammonia syngas purification system to the cracking furnace of the steam cracking unit to be used as fuel.

In examples, described is a process that may include generating a hydrogen gas containing stream in a blue ammonia unit; and directed the hydrogen gas containing stream to a steam cracking unit as fuel.

In examples, the process may include recovering a methane-rich gas stream in the steam cracking process; and directing the methane-rich gas stream to the blue ammonia unit as feed, fuel, or both.

In examples, the process may include recovering a hydrogen-rich gas stream from effluent cracked gas of a cracking furnace of the steam cracking unit.

In examples, the process may include directing the recovered hydrogen-rich to a cracking furnace of the steam cracking unit to be used as fuel.

In examples, the process may include supplementing the hydrogen-rich gas stream with a hydrogen gas containing stream from the blue ammonia unit.

In examples, the hydrogen gas containing stream may include at least a portion of a hydrogen-rich ammonia syngas stream generated from a hydrogen generation system of the blue ammonia unit.

In examples, the hydrogen gas containing stream may include at least a portion of a purified ammonia syngas stream generated by an ammonia syngas purification system of the blue ammonia unit.

In examples, the process may include directing the hydrogen-rich gas stream to a purification stage of the blue ammonia unit and directing at least a portion of a purified ammonia syngas stream generated by the ammonia syngas purification system to a cracking furnace of the steam cracking unit to be used as fuel.

In examples, the process may include compressing via a gas compressor at least a portion of the methane-rich gas stream directed to the blue ammonia unit prior to reaching the blue ammonia unit; expanding via a gas expander the hydrogen gas containing stream generated in the blue ammonia unit prior to reaching the steam cracking unit; and powering the gas compressor with an energy recovered from the gas expander.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIGS. 1A-1C are example diagrammatic illustrations of the integration process and system of a steam cracking unit and a blue ammonia unit.

FIGS. 2A-2C illustrate example diagrams of different implementations of a blue ammonia unit that may be integrated with a steam cracking unit as described.

FIGS. 3A and 3B illustrate example diagrams of cracking furnace systems of a steam cracking unit.

FIG. 4 illustrates an example of a recovery system of a steam cracking unit.

FIG. 5 illustrates example implementations for the integration of a steam cracking unit and a blue ammonia unit.

### DETAILED DESCRIPTION

In examples, a process and system are described herein to integrate a steam cracking unit with an ammonia unit. In examples, the ammonia unit is a blue ammonia unit. For purposes of this disclosure, the term “blue ammonia unit” is used to refer to a unit (or facility or system) that produced ammonia from natural gas while also capturing and storing carbon dioxide (CO2) emissions generated during the production process. In examples, the process and system as disclosed may achieve a low or zero CO2 emission through the integration of the steam cracking unit with the blue ammonia unit.

In examples, the steam cracking unit may include an olefin unit configured to produce one or more olefins through the thermal cracking of hydrocarbon feedstocks, such as for example, naphtha, ethane, propane, or butane, in the presence of steam. In examples, the high-temperature and high-pressure process can break down larger hydrocarbon molecules into smaller ones, primarily ethylene and propylene. In examples, olefins may be used in various industrial applications.

Recycling of hydrogen from the effluent gas of a cracking furnace of a steam cracking unit may be performed but often may be limited in the level of purity that it may generate. Hydrogen may be recovered in a steam cracking unit via a crude separation of the effluent product. In examples, the separation can separate out the olefin from the hydrogen and methane effluents. I example, further separation may lead to a hydrogen rich stream and a methane rich stream. In examples, the separation of hydrogen and methane may be carried out in a cold box to produce a high-pressure hydrogen-rich gas stream with purity of approximately 90-95 mol %, and a low-pressure methane-rich gas stream that is usually used as fuel gas. A portion of the hydrogen-rich gas stream can be injected into the methane-rich gas stream to achieve the necessary temperature driving force in the cold box to achieve the cooling and separation. As a result, the recovery of available hydrogen may be limited to approximately 80-85%.

Although this system may lower carbon emission, it may not be sufficient to achieve desired results.

To address some of these problems, disclosed herein is a process and system in which external hydrogen-rich gas generated in a blue ammonia unit may be used as fuel in the steam cracking unit. In examples, the process and system may integrate the steam cracking unit and the blue ammonia unit. In examples, the integration may be configured such that the tail gas from the steam cracking unit may be used as feed to the blue ammonia unit. In examples, the integration may be configured such that the blue ammonia unit can employed to achieve higher hydrogen concentration of the hydrogen-rich gas stream separated from the effluent gas of the cracking furnace of the steam cracking unit. In examples, the integration may be configured such that supplemental hydrogen to be imported to the cracker in the form of ammonia syngas to supplement and/or replace the hydrogen-rich gas stream.

In examples, the ammonia syngas may include approximately 75 mol % hydrogen and 25 mol % nitrogen. In examples, the process and system as described may reduce carbon emissions in the steam cracker. In examples, the carbon emission may be eliminated completely or almost completely.

Unless defined otherwise, all technical and scientific terms used herein have the same meaning as is commonly understood by one of skill in the art to which the inventions belong. All patents, patent applications, published applications and publications, websites and other published materials referred to throughout the entire disclosure herein, unless noted otherwise, are incorporated by reference in their entirety. Where there is a plurality of definitions for terms herein, those in this section prevail. Where reference is made to a URL or other such identifier or address, it is understood that such identifiers can change and information on the internet can come and go, but equivalent information can be found by searching the internet. Reference thereto evidences the availability and public dissemination of such information.

As used herein, the singular forms “a”, “an” and “the” include plural referents unless the context clearly dictates otherwise.

The terms first, second, third, etc. as used herein can describe various elements, components, regions, layers and/or sections, these elements, components, regions, layers and/or sections should not be limited by these terms. These terms may be only used to distinguish one element, component, region, layer or section from another region, layer, or section. Terms such as “first”, “second”, and other numerical terms when used herein do not imply a sequence or order unless clearly indicated by the context. Thus, a first element, component, region, layer, or section discussed below could be termed a second element, component, region, layer, or section without departing from the teachings of the example embodiments.

As used herein, ranges and quantities can be expressed as “about” a particular value or range. “About” also includes the exact amount. Hence “about 5 percent” means about 5 percent in addition to 5 percent. The term “about” means within typical experimental error for the application or purpose intended.

As used herein, “and/or” includes any and all combinations of one or more of the associated listed items.

As used herein, a “combination” refers to any association between two items or among more than two items. The association can be spatial or refer to the use of the two or more items for a common purpose.

As used herein, “comprising” and “comprises” are to be interpreted to mean “including but not limited to” and “includes but not limited to”, respectively.

As used herein, “optional” or “optionally” means that the subsequently described event or circumstance does or does not occur, and that the description includes instances where the event or circumstance occurs and instances where it does not. For example, an optional component in a system means that the component may be present or may not be present in the system.

As used herein, “substantially” means “being largely but not wholly that which is specified.”

As used herein, “negligible amount” refers to an amount that may be present in a concentration of 1 mol % or less.

In examples, the integration of a steam cracking unit and of a blue ammonia unit may include a transfer of one or more gas streams between the two units. In examples, ta methane-rich gas stream produced in the steam cracking unit may be directed to the ammonia unit to be used as feed, fuel, or both. In examples, a hydrogen-rich gas stream produced in the steam cracking unit may be supplemented by a hydrogen-rich ammonia syngas from the blue ammonia unit. In examples, a hydrogen-rich gas stream produced in the steam cracking unit may be directed to the blue ammonia unit for purification. In examples, a purified ammonia syngas stream may be directed from the blue ammonia unit to the steam cracking unit to be used as fuel.

For purposes of this disclosure “purified ammonia syngas stream” refers to a gas stream substantially containing hydrogen, or a mixture of hydrogen and nitrogen. In examples, the purified ammonia syngas stream will contain no more than negligible amounts of materials other than hydrogen or other than hydrogen and nitrogen. In examples, the purified ammonia syngas stream may contain pure hydrogen, i.e. >99.5 mol % hydrogen, or a mixture of hydrogen and nitrogen where the mixture makes up at least 99 mol % of the stream.

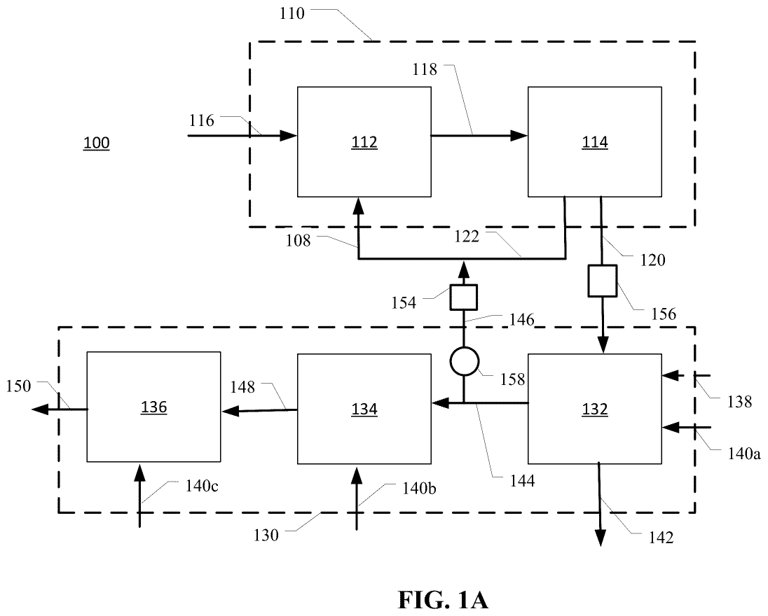

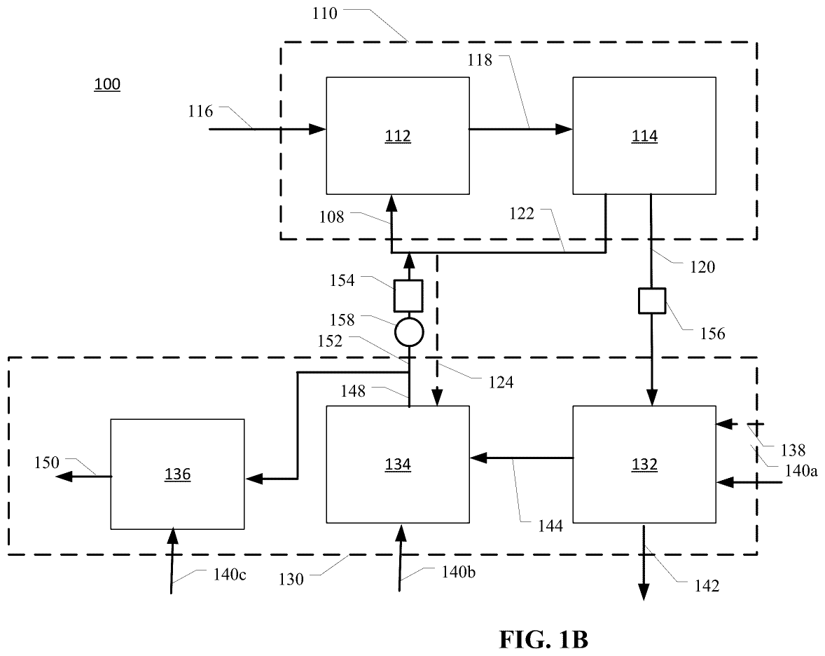

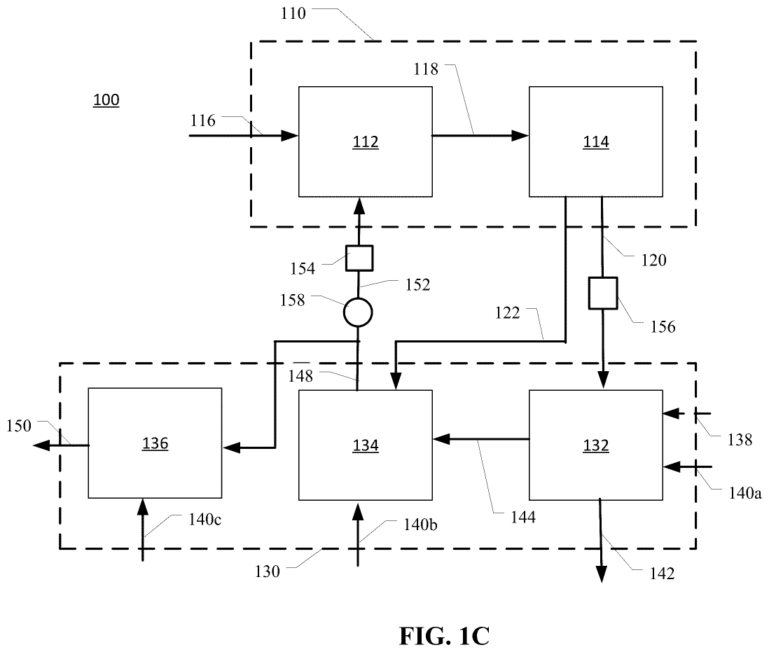

FIGS. 1A-1C provide diagrammatic illustrations of the integration process and system 100 of a steam cracking unit 110 and a blue ammonia unit 130. The same item numbers are used across FIGS. 1A to 1C to reference the same components and streams. In examples, the integration process and system 100 may include a steam cracking unit 110 in fluid communication with a blue ammonia unit 130.

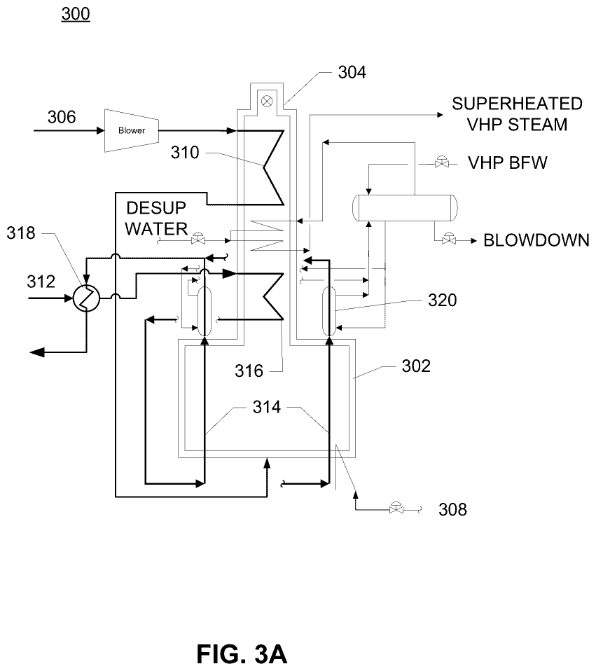

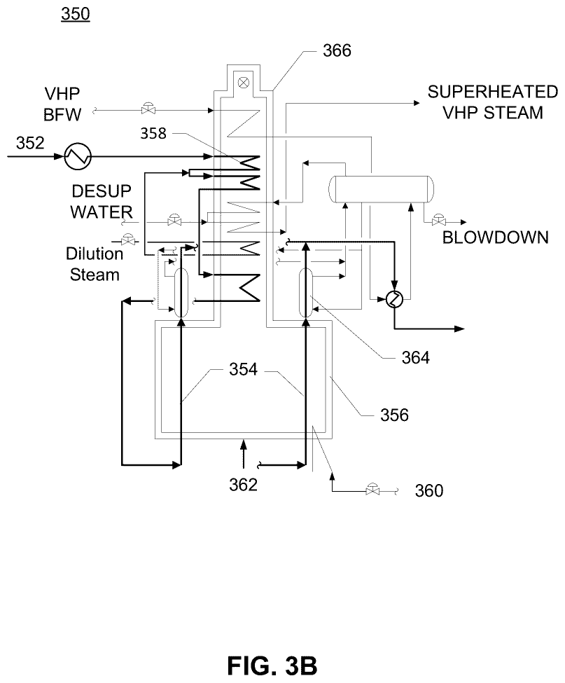

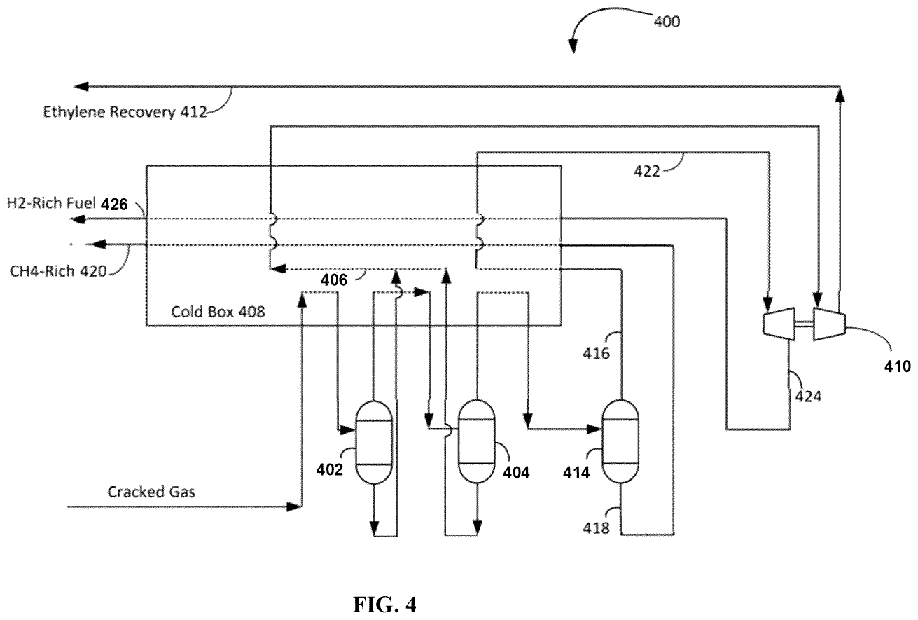

As illustrated, a steam cracking unit 110 may include a cracking furnace 112 and a recovery system 114. A hydrocarbon feed 116, that may be gas or liquid, may be fed to the cracking furnace 112. As the hydrocarbon feed 116 passes through one or more reactor tubes in cracking furnace 112, the hydrocarbon feed 116 may be cracked in the presence of steam at high temperature. The effluent cracked gas 118 of the cracking furnace 112 may include hydrogen, methane, and one or more olefins. In examples, the effluent cracked gas 118 may be directed to a recovery system 114 of the steam cracking unit 110. In examples, the recovery system 114 may separate from the effluent cracked gas 118 an olefin rich stream (not shown), a methane-rich gas stream 120, and a hydrogen-rich stream 122. In examples, the hydrogen-rich stream 122 may be recycled via a recycle line 108 configured to direct the hydrogen-rich stream 122 to the cracking furnace 112 to be used as fuel. Further detail of the steam cracking unit 110 is provided later with reference to FIGS. 3 and 4.

As illustrated in FIGS. 1A-1C, the blue ammonia unit 130 may include a hydrogen generation system 132, an ammonia syngas purification system 134, and an ammonia synthesis system 136. In examples, hydrogen generation system 132 may receive a natural gas feed 138, such as methane to be reacted with water vapor (not shown) to produce a hydrogen-rich ammonia syngas stream 144. In examples, an oxygen source such as air stream 140a may be fed to the hydrogen generation system 132 to provide oxygen to promote the generation of hydrogen and to provide nitrogen that may be used in the ammonia synthesis. In examples, air stream 140a may further include nitrogen. In examples, nitrogen may be supplied at the ammonia syngas purification system 134 via stream 140b, and/or at the ammonia synthesis system 136 via stream 140c in addition to and/or in place of stream 140a.

In examples, as shown, methane-rich gas stream 120 from the steam cracking unit 110 may be directed to the hydrogen generation system 132. In examples, the methane-rich gas stream 120 may be used as fuel to provide heat for the hydrogen generation. In examples, the methane-rich gas stream 120 may be used as feed in the same manner as hydrocarbon feed 138 to provide a hydrocarbon from which hydrogen can be recovered. In examples, the methane-rich gas stream 120 may be used as both fuel and feed for the hydrogen generation system 132. In examples, a portion of the methane-rich gas stream 120 may be used a fuel and another portion of the methane-rich gas stream 120 may be used as feed. In examples, at least a portion of the methane-rich gas stream 120 may be used as the only feed to the hydrogen generation system 132, i.e. replacing natural gas feed 138.

In examples, steam cracking unit 110 may be controlled such that the at least a portion of methane-rich gas stream 120 fed to the hydrogen generation system 132 to be used as hydrogen source to produce hydrogen may have a flow rate based the amount of hydrogen produced by the hydrogen generation system 132 of the blue ammonia unit 130. In examples, the amount of methane-rich gas in methane-rich gas stream 120 may be fed to the hydrogen generation system 132 for hydrogen production in a ratio of approximately 1 kg of methane-rich gas per about 1.5 kg to about 1.6 kg of purified ammonia syngas stream 148 output from the ammonia syngas purification system 134 of the blue hydrogen unit 130.

In examples, one or more controllers may be used to control the flow of methane-rich gas stream 120. In examples, the flow of methane-rich gas stream 120 fed to the hydrogen generation system 132 for hydrogen production may be controlled via one or more valves. In examples, a portion of methane-rich gas stream 120 may be diverted to be used as fuel by hydrogen generation system 132. In examples, the flow of methane-rich gas stream 120 fed to the hydrogen generation system 132 to produce hydrogen may be controlled by varying the amount of methane-rich gas stream 120 diverted to be used as fuel for the hydrogen generation system 132. In examples, variation of the flow to the feed of the hydrogen generation system 132 may control the amount of methane-rich gas stream 120 diverted to be used as fuel for the hydrogen generation system 132. In examples, (not shown) a portion of the methane-rich gas stream 120 may be withdrawn and either stored or otherwise disposed. In examples, flow rate of the methane-rich gas stream 120 to be fed to the hydrogen generation system 132 for hydrogen production, and/or to be used as fuel for the hydrogen generation system 132 may be controlled by varying an amount withdrawn from methane-rich gas stream 120. Any combination of these controls that may be actuated by one or more controllers and valve systems may be implemented to control the flow of methane-rich gas stream 120 or a portion thereof to the feed of hydrogen generation system 132 for hydrogen production, to be used as fuel by the hydrogen generation system 132, or both.

In examples, a carbon dioxide stream 142 generated by hydrogen generation system 132 may be captured via a carbon capture system (not shown).

In examples, as illustrated in FIG. 1A, a portion 146 of the hydrogen-rich ammonia syngas stream 144 from hydrogen generation system 132 may be directed to the steam cracking unit 110 to supplement the hydrogen-rich stream 122 as it is fed to the cracking furnace 112 as fuel. In examples, supplementing hydrogen-rich stream 122 may lead to lower carbon emission in the flue gas of the cracking furnace 112.

In examples, as shown in FIGS. 1A-1C, the remaining portion of hydrogen-rich ammonia syngas stream 144 may be fed to an ammonia syngas purification system 134 that removes at least a portion of any hydrocarbons or other extraneous gasses not used for ammonia production to yield a purified ammonia syngas stream 148. In examples, the purified ammonia syngas stream 148 may be directed to the ammonia synthesis system 136 for ammonia production that yields an ammonia stream 150.

It should be noted that in examples where nitrogen is introduced into the blue ammonia unit only at stream 140c, that purified ammonia syngas stream 148 may include a high purity hydrogen stream with a hydrogen concentration of at least 99.5 mol %. Instead, where nitrogen is introduced with streams 140a and/or 140b, the purified ammonia syngas stream 148 may include a gas mixture of hydrogen and nitrogen. In examples, the purified ammonia syngas stream 148 may include a mixture of about >74 mol % hydrogen and about >24 mol % nitrogen, with potentially only negligible amounts of other gases.

In examples, as illustrated in FIG. 1B, a portion 152 of the purified ammonia syngas stream 148 from the ammonia syngas purification system 134 may be directed to the steam cracking unit 110 to supplement the hydrogen-rich stream 122 as it is fed to the cracking furnace 112 as fuel. This can be done in place of or in addition to directing portion 146 of the hydrogen-rich ammonia syngas stream 144 to the steam cracking unit 110 as described with reference to FIG. 1A. In examples, by directing portion 152 instead of portion 146 it may be possible to increase the hydrogen concentration in the hydrogen-rich stream 122 that is directed to the cracking furnace 112 to be used as fuel. In examples, as also shown in FIG. 1B, at least a portion 124 of hydrogen-rich stream 122 from the recovery system 114 may optionally be directed to the ammonia syngas purification system 134 to further remove hydrocarbons such as methane from the stream. In this manner, the hydrogen concentration of the hydrogen-rich stream 122 that is ultimately sent to the cracking furnace 112 to be used as fuel may include an even higher hydrogen concentration. In examples, higher hydrogen concentration means lower hydrocarbon or methane concentration and thus a lower carbon emission in the flue gas of the cracking furnace 112.

In examples, the remaining portion of purified ammonia syngas stream 148 may be directed to ammonia synthesis system 136 to produce ammonia stream 150 as described earlier.

In examples, as illustrated in FIG. 1C, all of the hydrogen-rich stream 122 may be sent to the ammonia syngas purification system 134. In this example, portion 152 of the purified ammonia syngas stream 148 directed to the steam cracking unit 110 may be the only fuel sent to the cracking furnace 112. In examples, portion 152 of the purified ammonia syngas stream 148 may include a high purity hydrogen stream, i.e. with a hydrogen concentration of at least 99.5 mol % or a mixture of hydrogen and nitrogen that includes a mixture of about >74 mol % hydrogen and about >24 mol % nitrogen, with potentially only negligible amounts of other gases. In examples, either option would limit if not eliminate methane or other hydrocarbons from the fuel stream to cracking furnace 112 thereby limiting or eliminating the carbon emission from the flue gas of the cracking furnace 112.

As described with reference to FIG. 1B, in examples, the remaining portion of purified ammonia syngas stream 148 may be directed to ammonia synthesis system 136 to produce ammonia stream 150 as described earlier.

In examples, by the above integration schemes it may be possible to take advantage of the blue ammonia unit 130 to supplement or further purify the hydrogen fuel to be fed to the cracking furnace 112 to thus lower or eliminate carbon emission. In examples, by the above integration schemes it may be possible to utilize the methane-rich gas stream 120 recovered by the recovery system 114. In examples, the integration may allow to take advantage of the carbon capture system of the blue ammonia system to lower or eliminate carbon emission. In examples, the integration as described may be implemented without interfering with the production of ammonia in the blue ammonia unit 130.

In examples, as illustrated in FIGS. 1A-1C, the integration process and system 100 may include one or more gas expanders 154 and/or gas compressors 156. In examples, the pressure of one or more hydrogen gas containing streams from the blue ammonia unit 130 to the steam cracking unit 110, i.e. portion 146 of the hydrogen-rich ammonia syngas stream 144 and/or portion 152 of the purified ammonia syngas stream 148, may be reduced based on the steam cracker fuel gas back-pressure. In examples, the integration system and process 100 may include one or more gas expanders 154 to reduce the pressure of these streams. In examples, a type of gas expander 154 suitable for this use may be a turbo-expander. In examples, the gas expander 154, such as the turbo-expander, may be configured to recover energy, such as electrical power, when expanding the hydrogen gas containing stream.

In examples, preheating of the one or more hydrogen gas containing streams from the blue ammonia unit 130 to the steam cracking unit 110 may optionally be carried out. In examples, the integration system or process 100 may include one or more heaters 158. In examples, a heater 158 may be an electric heater, a heat exchanger, or any other suitable heating means. In examples, the one or more heaters 158 may be arranged so as to preheat a hydrogen gas containing stream coming from the blue ammonia unit before pressure reduction by one or more gas expanders 154. In this manner, in examples, it may be possible to maximize the recovery of electrical power. In examples, the target preheat amount may be set to achieve an expander outlet temperature near ambient temperature.

In examples, the methane-rich gas stream 120 being directed from the steam cracking unit 110 to the blue ammonia unit 130 may be at a relatively low-pressure. In examples, the pressure of methane-rich gas stream 120 may be about 3 barg to about 8 barg. In examples, the integration system and process 100 may include one or more gas compressors 156. In examples, one or more gas compressors 156 may be arranged and configured to compress at least a portion of the methane-rich gas stream 120 to a desired blue ammonia unit feed gas pressure.

In examples, the power to a gas compressor 156 may be from a source other than gas expander 154. In examples, the one or more gas compressors 156 used to compress the methane-rich gas stream may be powered by the energy recovered by the one or more gas expanders 154. In examples, it may be possible to employ a gas expander 154 to drive the gas compressor 156 in a direct-coupled arrangement. In examples, it may be possible to employ a gas expander 154 to generate power from the expanding the gas stream, and that power could then be applied to offset the power required to drive the methane-rich gas compressor 156 and/or to power other equipment and/or to be stored for later use.

In examples, the manner of implementation of the integration may be conditioned on the nature of the blue ammonia unit. Different types of blue ammonia units may be used in the integration as will be discussed below. Although implementation may vary based on the nature of the blue ammonia unit, the integration as described remains equally applicable across different types blue ammonia units.

It is noted that the hydrogen-rich stream generated from cracking unit, the hydrogen-rich ammonia syngas stream and the purified ammonia syngas stream from the blue ammonia unit, and all portions thereof, as referenced throughout this disclosure can be generally referred to as hydrogen gas streams. The differences between these hydrogen gas streams may be the concentration of the hydrogen gas present in each stream and/or the presence and/or absence of one or more additional species in each stream as described throughout this disclosure.

### Ammonia Synthesis Technology

### Type 1:

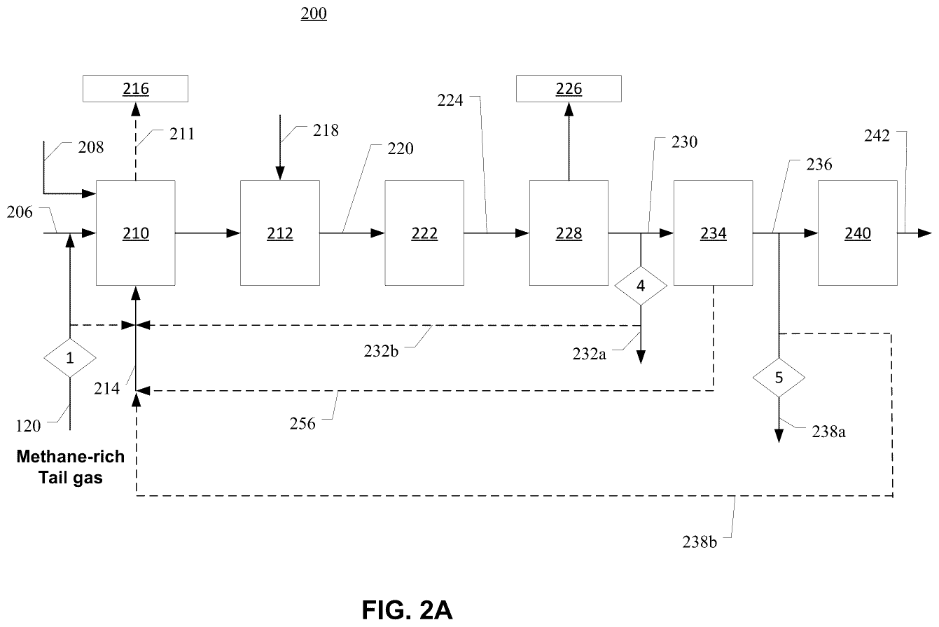

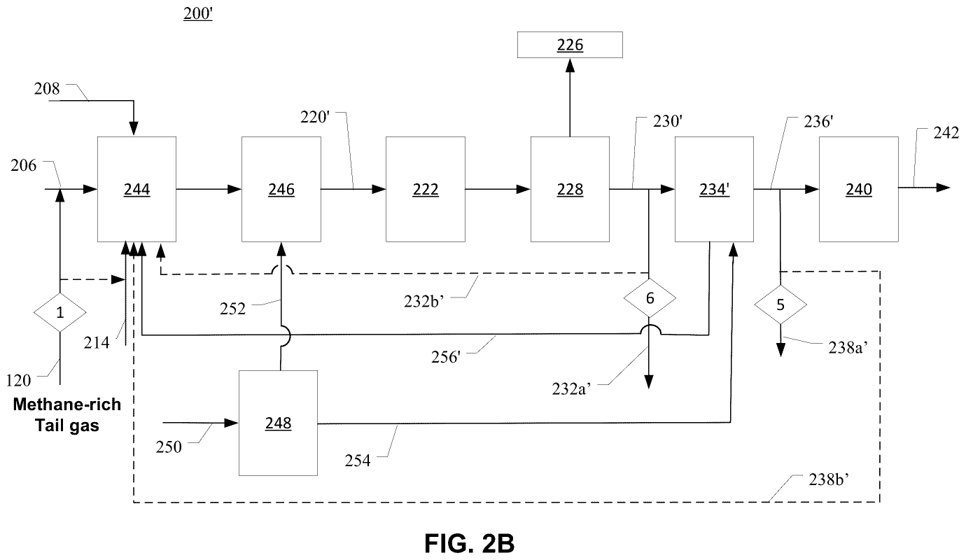

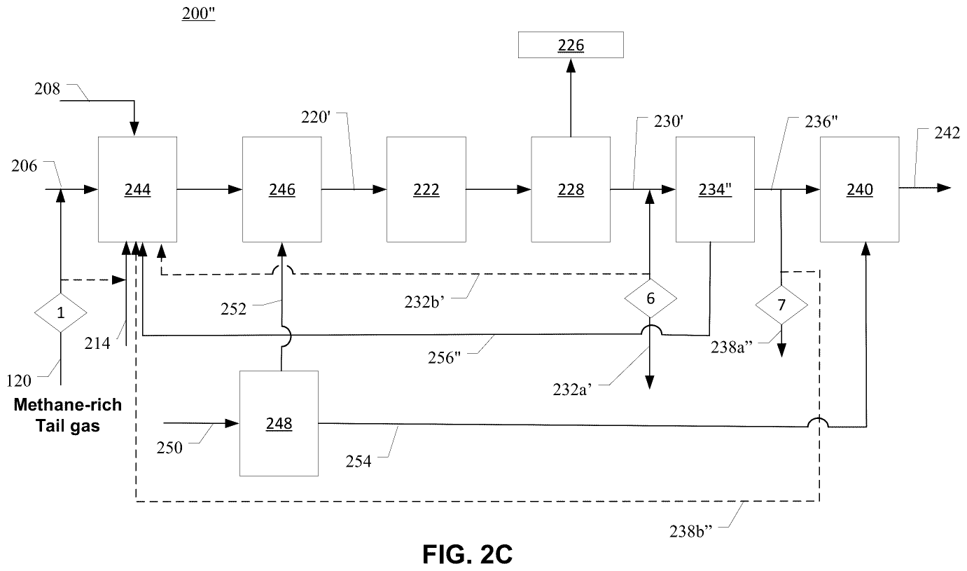

In examples, a blue ammonia unit 130 for ammonia production may be implemented as described below with reference to FIGS. 2A-2C. The described ammonia synthesis processes are only illustrative to demonstrate the application of the integration across different variations of blue ammonia units. Any blue ammonia units may equally be integrated with a steam cracking unit in the same or similar manner as described herein.

In examples, a blue ammonia unit 130 illustrated for the integration with a steam cracking unit may include a steam-methane reformer (SMR) system as hydrogen generation system 132.

Steam-methane reforming (SMR) is a widely used industrial process for producing hydrogen gas (H2) from the reaction of natural gas (e.g., methane, CH4) and steam (water vapor). In examples, the SMR process can produce hydrogen gas (H2) and carbon monoxide (CO) through a series of chemical reactions. In examples, the reaction may be carried out at high temperatures, for example, between about 700° C. and 1,000° C., and under pressure. In examples, the heating for the SMR process may be provided by electric means and/or by burning fuel.

For example, in an initial step, the hydrocarbon or methane can react with the water molecule in steam to yield a carbon monoxide and hydrogen as illustrated by equation (1):

CH4+H2O→CO+3H2 (1)

In examples, the hydrogen gas produced by the SMR process may then be combined with nitrogen for ammonia synthesis.

In examples, as shown in FIG. 2A, the SMR of a blue ammonia unit 200 may include a primary reformer 210 and a secondary reformer 212. In examples, the two reformers 210 and 212 may be in series. In examples, primary reformer 210 and secondary reformer 212 may be used to generate hydrogen from methane and steam.

In examples, the primary reformer 210 may include a feed 206. In examples, feed 206 may include a natural gas feed. In examples, feed 206 may include one or more hydrocarbons. In examples, feed 206 may include methane. In examples, feed 206 may at least in part be supplied by a methane-rich gas stream 120 from the steam cracking unit. In examples, at least a portion of a methane-rich gas stream from the steam cracking unit makes up the complete feed 206 to primary reformer 210. In examples, feed 206 may supplied at least in party by an independent source.

In examples, in primary reformer 210, the methane from feed 206 may be reacted with steam to produce carbon monoxide and hydrogen gas. In examples, steam may be provided to primary reformer 210 via a steam feed 208. In examples, heat for the reaction may be provided to the primary reformer 210 by an electric heater, burning fuel, or any combination thereof. In examples, heat in primary reformer 210 may be provided at least in part by burning a fuel 214. In examples, fuel 214 may include a hydrocarbon, for example, methane. In examples, fuel 214 may at least in part be supplied by a methane-rich gas stream 120 from the steam cracking unit. In examples, at least a portion of a methane-rich gas stream from the steam cracking unit is the only fuel 214 used for primary reformer 210. In examples, fuel 214 may supplied by an independent source.

In examples, the flue gas 211 generated from burning a methane or other natural gas containing fuel in primary reformer 210 may include carbon dioxide. In examples, where hydrocarbon containing fuel is used to generate heat in the primary reformer 210, a carbon capture system 216 may be implemented to avoid or minimize carbon emission. In examples, the fuel used to generate heat in the primary reformer 210 may be free of methane or other hydrocarbons and thus no carbon dioxide may be present in the flue gas. In examples, where there is little to no carbon dioxide in the flue gas from burning of fuel in a reformer, the carbon capture system 216 may not be present.

In examples, the effluent from the primary reformer 210 may be fed to the secondary reformer 212 of the SMR process. In examples, a compressed air stream 218 may be introduced into the secondary reformer 212 to combust a portion of the natural gas or hydrocarbons in the feed to generate heat for reaction. In examples, compressed air stream 218 may include regular air as source of nitrogen and oxygen for secondary reforming of methane. In such examples, a pure hydrogen stream may not be produced anywhere in the process. In examples, compressed air stream 218 may be the only source of nitrogen. In examples, during this combustion oxygen (O₂) may be depleted while the stoichiometric nitrogen (N₂) may remain for use downstream in the generation of ammonia. In examples, the generation of hydrogen continues in the secondary reformer 212.

In examples, the effluent of the secondary reformer 212 may include a syngas mixture 220. In examples, the syngas mixture 220 may include hydrogen, carbon monoxide, carbon dioxide, unreacted steam, unreacted methane or other hydrocarbons, and nitrogen.

In examples, the blue ammonia unit 200 may include a water-gas shift reactor (WGS) 222. In examples, the WGS 222 may be a two-stage water gas shift reactor. In examples, WGS 222 may be in line after the secondary reformer 212. In examples, syngas mixture 220 from secondary reformer 212 may be fed to WGS 222. In examples, the syngas mixture 220 may be cooled before it is sent to the WGS 222. In examples, in the WGS 222 the syngas mixture 220 may undergo further reaction to increase the hydrogen yield.

In examples, the carbon monoxide produced in the SMR and contained in syngas mixture 220 may be further reacted in the WGS with steam to generate additional hydrogen and carbon dioxide as illustrated by equation (2):

CO+H2O→CO2+H2 (2)

The WGS effluent 224 outlet from WGS 222 may include a modified syngas mixture. In examples, WGS effluent 224 may include a higher hydrogen concentration than syngas mixture 220.

In examples, the WGS effluent 224 may be fed to a CO2 separator 228 connected to a carbon capture system 226 to which the separated CO2 may be sent. In examples, any carbon capture technology known in the art may employed for carbon capture system 226 and for optional carbon capture system 216. In examples, the carbon capture systems 226 and 216 may be the same or different. In examples, CO2 separator 228 may include any suitable system that can sequester CO2 from the WGS effluent 224. In examples, CO2 separator 228 may include a mono-ethanol-amine scrubbing process. In examples, the CO2 separator 228 may include a Selexol process in which dimethyl ethers of polyethylene glycol (DEPG) may be used to selectively remove carbon dioxide from the WGS effluent 224. These are just examples and other systems may also be included. In examples, a CO2 separator 228 may include a methanation process. In examples, a methanation process may convert any leftover carbon monoxide into methane. This may avoid poisoning the ammonia synthesis downstream and/or provide methane for recycling.

The effluent from the CO2 separator 228 may include a hydrogen-rich ammonia syngas stream 230. In examples, the hydrogen-rich ammonia syngas stream 230 may include hydrogen, nitrogen, and methane. In examples, hydrogen gas may be the major component of the hydrogen-rich ammonia syngas stream 230. In examples, methane gas may be present in only small amounts. In examples, the hydrogen-rich ammonia syngas stream 230 may include at greater than 64 mol % hydrogen. In examples, the hydrogen-rich ammonia syngas stream 230 may include at greater than 32 mol % nitrogen. In examples, the hydrogen-rich ammonia syngas stream 230 may include less than 3 mol % methane gas or other hydrocarbons. In examples, hydrogen-rich ammonia syngas stream 230 may include 65 mol % hydrogen, 33 mol % nitrogen, and 2 mol % methane gas.

In examples, as shown in FIG. 2A, a portion 232a of hydrogen-rich ammonia syngas stream 230 may be directed to the steam cracking unit to supplement a hydrogen-rich stream recovered by a recovery system of the steam cracking unit to be used as fuel for the cracking furnace. In examples, the remaining portion of hydrogen-rich ammonia syngas stream 230 may be directed to a syngas purification system 234. In examples, portion 232a of hydrogen-rich ammonia syngas stream 230 is not directed to the steam cracking unit and all of the hydrogen-rich ammonia syngas stream 230 is sent to the syngas purification system 234.

In examples, a portion 232b of hydrogen-rich ammonia syngas stream 230 may be used as fuel for the SMR process. In examples, a portion 232b of hydrogen-rich ammonia syngas stream 230 may be combined with and/or used in place of fuel 214. In examples, the portion 232b of hydrogen-rich ammonia syngas stream 230 may be combined with at least a portion of the methane-rich gas from the integrated steam cracking unit to be used as fuel to supplement and/or substitute fuel 214.

In examples, the blue ammonia unit 130 may include an ammonia syngas purification system 134 implemented as syngas purification system 234.

In examples, the syngas purification system 234 may include a purifier. In examples, the purifier may include an apparatus for cryogenic purification of syngas. In examples, the syngas purification system 234 may be configured to remove methane gas or other hydrocarbons from hydrogen-rich ammonia syngas stream 230. In examples, the syngas purification system 234 may be configured to remove at least a portion of any methane gas or other hydrocarbons that may be present in hydrogen-rich ammonia syngas stream 230. In examples, the syngas purification system 234 may be configured to remove all methane gas or other hydrocarbons or carbon species that may be present in hydrogen-rich ammonia syngas stream 230. In examples, the effluent of syngas purification system 234 may include a purified ammonia syngas stream 236.

In examples, the syngas purification system 234 may include a discard stream 256 including the removed methane gas or other hydrocarbons or carbon species from the hydrogen-rich ammonia syngas stream 230. In examples, discard stream 256 or a portion thereof may be directed to SMR primary reformer 210 to be used as fuel. In examples, discard stream 256 may supplement and/or replace fuel stream 214 and/or the methane rich gas, or portion thereof, from the integrated steam cracking unit if used as fuel for the SMR primary reformer 210. In examples, if desired, the discard stream 256 or a portion thereof may be directed to the cracking furnace of the integrated steam cracking unit to be used as fuel.

In examples, purified ammonia syngas stream 236 may include no more than negligible amounts of hydrocarbons. In examples, at least 99 mol % of purified ammonia syngas stream 236 is composed of a mixture of hydrogen and nitrogen. In examples, purified ammonia syngas stream 236 may include at least 74 mol % hydrogen. In examples, purified ammonia syngas stream 236 may include at least 24 mol % nitrogen. In examples, the purified ammonia syngas stream 236 may include 75 mol % hydrogen and 25 mol % nitrogen.

In examples, a portion 238a of purified ammonia syngas stream 236 may be directed to the steam cracking unit to supplement a hydrogen-rich stream recovered by a recovery system of the steam cracking unit to be used as fuel for the cracking furnace. In examples, the remaining portion of purified ammonia syngas stream 236 may be directed to an ammonia synthesis system 240. In examples, portion 238a of purified ammonia syngas stream 236 is not directed to the steam cracking unit and all of the purified ammonia syngas stream 236 is sent to the ammonia synthesis system 240.

In examples, a portion 238a of purified ammonia syngas stream 236 may be directed to the steam cracking unit only when a portion 232a of hydrogen-rich ammonia syngas stream 230 is not directed to the steam cracking unit. In examples, a portion 232a of hydrogen-rich ammonia syngas stream 230 may be directed to the steam cracking unit only when, a portion 238a of purified ammonia syngas stream 236 is not directed to the steam cracking unit. In examples, a portion 232a of hydrogen-rich ammonia syngas stream 230 and a portion 238a of purified ammonia syngas stream 236 may both be directed to the steam cracking to supplement a hydrogen-rich stream recovered by a recovery system of the steam cracking unit to be used as fuel for the cracking furnace.

In examples, the integrated system and process as described herein may be configured to affect the hydrogen concentration of the fuel feed to the cracking furnace by controlling and/or adjusting the supplementation of the hydrogen-rich stream recovered by a recovery system of the steam cracking unit with portion 232a of hydrogen-rich ammonia syngas stream 230 and/or portion 238a of purified ammonia syngas stream 236.

In examples, a portion 238b of purified ammonia syngas stream 236 may be used as fuel for the SMR process. In examples, a portion 238b of purified ammonia syngas stream 236 may be combined with and/or used in place of fuel 214. In examples, portion 238b of purified ammonia syngas stream 236 may be combined with at least a portion of the methane-rich gas from the integrated steam cracking unit to be used as fuel to supplement and/or substitute fuel 214. In examples, portion 238b of purified ammonia syngas stream 236 may be used to supplement and/or substitute fuel 214 in place of and/or together with portion 232b of hydrogen-rich ammonia syngas stream 230. In examples, the portion 238b of purified ammonia syngas stream 236 may have lower to not hydrocarbon or methane content thus reducing and/or eliminating carbon emission when used a fuel for the SMR process.

In examples, the blue ammonia unit 130 may include an ammonia synthesis system 136 implemented as ammonia synthesis system 240.

In examples, at least some of the purified ammonia syngas stream 236 is not redirected to either the integrated steam cracking unit or to the SMR process. In examples, the at least some purified ammonia syngas stream 236 not being redirected elsewhere may be fed to the ammonia synthesis system 240 may be used to form ammonia. In examples, the effluent of ammonia synthesis system 240 may include an ammonia stream 242.

### Type 2.

In examples, a blue ammonia unit 130 illustrated for the integration with a steam cracking unit may include an autothermal reformer (ATR) as at least a portion of the hydrogen generation system 132.

In examples, the blue ammonia unit may be implemented as illustrated in FIG. 2B. The same item numbers indicate the same or similar components as FIG. 2A. To the extent a difference is present in the same item of FIGS. 2A and 2B, the item is annotated with a (′).

In examples, blue ammonia unit 200′ may include a steam pre-reformer 244 and an autothermal reformer (ATR) 246 in place of the SMR process described with reference to FIG. 2A. In examples, blue ammonia unit 200′ may include an air separation unit (ASU) 248.

In examples, natural gas feed 206 which may, at least in part, include a methane-rich gas stream from the steam cracking unit, may be fed to the steam pre-reformer 244. In examples, the methane-rich gas stream from the steam cracking unit may make up the complete natural gas feed 206. In examples, methane-rich gas stream from the steam cracking unit, may supplement natural gas feed 206. In examples, at least a portion of natural gas feed 206 may be sourced from a source other than the integrated steam cracking unit.

In examples, a steam stream 208 may be fed to the steam pre-reformer 244. In examples, in the steam pre-reformer 244 the methane and other heavier hydrocarbons that may be present may be steam reformed. In examples, products of the heavier hydrocarbon reforming may also be methanated.

In examples, steam pre-reformer 244 may use a catalyst. In examples, the catalyst may include nickel. In examples, the reaction in steam pre-reformer 244 may require heat. In examples, the heat for steam pre-reformer 244 may be provided by one or more electronic heaters and/or by burning fuel. In examples, a fuel 214 as similarly discussed with reference to FIG. 2A may be used. In examples, as also previously discussed with reference to FIG. 2A, fuel 214 may be supplemented and/or replaced by at least a portion of a methane-rich gas stream from the integrated steam cracking unit.

In examples, one or more of the following three reactions may occur in the steam pre-reformer 244:

Steam reforming reaction of equation (3):

CH4+H2O→CO+3H2 (3)

Water gas shift reaction of equation (4):

CO+H2O→H2+CO2 (4)

Methanation of equation (5):

CO+3H2→CH4+H2O (5)

In examples, the effluent from steam pre-reformer 244 may be fed to ATR 246. In examples, an ASU 248 may be configured to include an air feed 250 and output an oxygen stream 252 and a nitrogen stream 254. Other air separation systems may also be employed. In examples, either or both oxygen stream 252 and nitrogen stream 254 may include negligible amounts of other gases. In examples, either or both oxygen stream 252 and nitrogen stream 254 may be pure gases with respective oxygen and nitrogen concentrations of 99 mol % or higher.

In examples, the oxygen stream 252 from ASU 248 may be fed to the ATR 246. In examples, in ATR 246 oxygen and carbon dioxide or steam may react with methane, producing hydrogen. In examples, the reaction in ATR 246 may occur without requiring external heat input. This reaction may occur in a single chamber where methane gets partially oxidized. In examples, the reactions that may be taking place in the ATR 246 may include either or both of equations (6) and (7):

2CH4+O2+CO2→3H2+3CO+H2O (6)

4CH4+O2+2H2O→10H2+4CO (7)

The effluent from ATR 246 may thus include a syngas mixture 220′. In examples, syngas mixture 220′ may be fed to a water-gas shift reactor (WGS) 222 and the effluent from the WGS 222 may then be fed to a CO2 separator 228 as described earlier with reference to FIG. 2A.

In examples, the effluent from the CO2 separator 228 may include a hydrogen-rich ammonia syngas stream 230′. In examples, the hydrogen-rich ammonia syngas stream 230′ may include hydrogen, and methane. In the system of FIG. 2B the hydrogen-rich ammonia syngas stream 230′ may be substantially free of nitrogen since no nitrogen or no significant amount of nitrogen was introduced in the process prior to CO2 separator 228. In examples, the hydrogen-rich ammonia syngas stream 230′ may contain only negligible amounts of nitrogen. In examples, the hydrogen-rich ammonia syngas stream 230′ may be free of nitrogen. In examples, the hydrogen-rich ammonia syngas stream 230′ may contain mostly hydrogen. In examples, the hydrogen-rich ammonia syngas stream 230′ may contain hydrogen in a concentration of 96 mol % or greater. In examples, the balance of the hydrogen-rich ammonia syngas stream 230′ may substantially include methane gas. In examples, the hydrogen-rich ammonia syngas stream 230′ may include 4 mol % or less methane gas. In examples, a negligible amount of other materials other than hydrogen and methane may be present in the hydrogen-rich ammonia syngas stream 230′.

In examples, as similarly described with reference to FIG. 2A, at least a portion 232a′ of hydrogen-rich ammonia syngas stream 230′ may be directed to the steam cracking unit to supplement a hydrogen-rich stream recovered by a recovery system of the steam cracking unit to be used as fuel for the cracking furnace. In examples, the remaining portion of hydrogen-rich ammonia syngas stream 230′ may be directed to a syngas purification system 234′. In examples, portion 232a′ of hydrogen-rich ammonia syngas stream 230′ is not directed to the steam cracking unit and all of the hydrogen-rich ammonia syngas stream 230′ is sent to the syngas purification system 234′.

In examples, another portion 232b′ of hydrogen-rich ammonia syngas stream 230′ may be used as fuel for the SMR process. In examples, a portion 232b′ of hydrogen-rich ammonia syngas stream 230′ may be combined with and/or used in place of fuel 214. In examples, the portion 232b′ of hydrogen-rich ammonia syngas stream 230′ may be combined with at least a portion of the methane-rich gas from the integrated steam cracking unit to be used as fuel to supplement and/or substitute fuel 214.

In examples, the blue ammonia unit 130 may include an ammonia syngas purification system 134 implemented as syngas purification system 234′.

In examples, at least a portion of a hydrogen-rich gas stream from the steam cracking unit may be combined with hydrogen-rich ammonia syngas stream 230′ prior to directing the hydrogen-rich ammonia syngas stream 230′ to the syngas purification system 234′. In examples, by combining at least a portion of a hydrogen-rich gas stream from the steam cracking unit with the hydrogen-rich ammonia syngas stream 230′ it may be possible to take advantage of the syngas purification system 234′ of the blue ammonia unit 200′ to further purify at least that portion of the hydrogen-rich gas stream from the steam cracking unit. In examples, the full hydrogen-rich gas stream from the steam cracking unit intended to be used as fuel in the cracking furnace of the steam cracking unit may be combined with the hydrogen-rich ammonia syngas stream 230′ ahead of the syngas purification system 234′.

In examples, the syngas purification system 234′ may include any suitable purification equipment. In examples, syngas purification system 234′ may include absorber column, a wash column, or combination thereof. In examples, the syngas purification system 234′ may be configured to remove at least a portion of any methane gas or other hydrocarbons or carbon species that may be present in hydrogen-rich ammonia syngas stream 230′. In examples, liquid nitrogen may be used in syngas purification system 234′ as a wash stream to separate out carbon species. In examples, syngas purification system 234′ may include a nitrogen feed 254. In examples, the nitrogen stream 254 from ASU 248 may be fed to the syngas purification system 234′ and/or mixed with the product gas of syngas purification system 234′. In examples, the nitrogen feed 254 may be fed as gas, liquid, or both to syngas purification system 234′. In examples, a portion of nitrogen feed 254 may be expanded and thus liquified to provide a liquid nitrogen wash stream to be used in syngas purification system 234′. In examples, a portion of nitrogen feed 254 may be introduced as gas to provide nitrogen source for the ammonia synthesis.

In examples, the syngas purification system 234′ may include a discard stream 256′ including the removed methane gas or other hydrocarbons or carbon species from the hydrogen-rich ammonia syngas stream 230′. In examples, discard stream 256′ or a portion thereof may be directed to steam pre-reformer 244 to be used as fuel. In examples, discard stream 256′ may supplement and/or replace fuel stream 214 and/or the methane rich gas, or portion thereof, from the integrated steam cracking unit if used as fuel for the steam pre-reformer 244. In examples, if desired, the discard stream 256′ or a portion thereof may be directed to the cracking furnace of the integrated steam cracking unit to be used as fuel.

In examples, the effluent of syngas purification system 234′ with the mixed in nitrogen from nitrogen stream 254 may include a purified ammonia syngas stream 236′. In examples, purified ammonia syngas stream 236′ may include no more than negligible amounts of hydrocarbons. In examples, at least 99 mol % of purified ammonia syngas stream 236′ is composed of a mixture of hydrogen and nitrogen. In examples, purified ammonia syngas stream 236′ may include at least 74 mol % hydrogen. In examples, purified ammonia syngas stream 236′ may include at least 24 mol % nitrogen. In examples, the purified ammonia syngas stream 236′ may include 75 mol % hydrogen and 25 mol % nitrogen.

In examples, as similarly described earlier with reference to FIG. 2A, a portion 238a′ of purified ammonia syngas stream 236′ may be directed to the steam cracking unit to supplement a hydrogen-rich stream recovered by a recovery system of the steam cracking unit to be used as fuel for the cracking furnace. In examples, where the full hydrogen-rich gas stream from the steam cracking unit intended to be used as fuel in the cracking furnace of the steam cracking unit is combined with the hydrogen-rich ammonia syngas stream 230′ ahead of the syngas purification system 234′, the portion 238a′ of purified ammonia syngas stream 236′ directed to the steam cracking unit may constitute the only hydrogen containing fuel stream supplied to the cracking furnace of the steam cracking unit. In examples, the remaining portion of purified ammonia syngas stream 236′ may be directed to an ammonia synthesis system 240. In examples, portion 238a′ of purified ammonia syngas stream 236′ is not directed to the steam cracking unit and all of the purified ammonia syngas stream 236′ is sent to the ammonia synthesis system 240.

In examples, a portion 238a′ of purified ammonia syngas stream 236′ may be directed to the steam cracking unit only when a portion 232a′ of hydrogen-rich ammonia syngas stream 230′ is not directed to the steam cracking unit. In examples, a portion 232a′ of hydrogen-rich ammonia syngas stream 230′ may be directed to the steam cracking unit only when a portion 238a′ of purified ammonia syngas stream 236′ is not directed to the steam cracking unit. In examples, a portion 232a′ of hydrogen-rich ammonia syngas stream 230′ and a portion 238a′ of purified ammonia syngas stream 236′ may both be directed to the steam cracking to supplement a hydrogen-rich stream recovered by a recovery system of the steam cracking unit to be used as fuel for the cracking furnace.

In examples, a portion 238b′ of purified ammonia syngas stream 236′ may be used as fuel for the pre-reformer 244. In examples, a portion 238b′ of purified ammonia syngas stream 236′ may be combined with and/or used in place of fuel 214. In examples, portion 238b′ of purified ammonia syngas stream 236′ may be combined with at least a portion of the methane-rich gas from the integrated steam cracking unit to be used as fuel to supplement and/or substitute fuel 214. In examples, portion 238b′ of purified ammonia syngas stream 236′ may be used to supplement and/or substitute fuel 214 in place of and/or together with portion 232b′ of hydrogen-rich ammonia syngas stream 230′. In examples, the portion 238b′ of purified ammonia syngas stream 236′ may have lower to not hydrocarbon or methane content thus reducing and/or eliminating carbon emission when used a fuel for the pre-reformer 244.

In examples, the integrated system and process as described herein may be configured to affect the hydrogen concentration of the fuel feed to the cracking furnace by controlling and/or adjusting the supplementation of the hydrogen-rich stream recovered by a recovery system of the steam cracking unit with portion 232a′ of hydrogen-rich ammonia syngas stream 230′ and/or portion 238a′ of purified ammonia syngas stream 236′ or by substituting the hydrogen-rich stream recovered by a recovery system of the steam cracking unit with a portion 238a′ of purified ammonia syngas stream 236′ as described above.

In examples, as similarly described with reference to FIG. 2A, at least some of purified ammonia syngas stream 236′ is fed to the ammonia synthesis system 240 to be reacted to form ammonia. In examples, the effluent of ammonia synthesis system 240 may include an ammonia stream 242.

### Type 3:

In examples, the blue ammonia unit may be implemented as illustrated in FIG. 2C. The same item numbers indicate the same or similar components as the previous FIG. 2B. To the extent a difference is present in the same item of FIG. 2C and FIG. 2B, the item is annotated with a (″).

In examples, blue ammonia unit 200″ of FIG. 2C may be set up and include the same components as blue ammonia unit 200′ described with reference to FIG. 2B with the exception of input location of the nitrogen stream 254 and of the syngas purification system 234″. As shown in FIG. 2C, nitrogen stream 254″ air separation unit (ASU) 248 may be directed to ammonia synthesis system 240 to combine with hydrogen and produce an ammonia stream 242.

In examples, the syngas purification system 234″ may include a purifier. In examples, the purifier may include pressure swing adsorption (PSA) process. In examples, a PSA process refers to a technique in which a gas species may be separated from a mixture of gases under pressure using an adsorbent material. A PSA process may be operated at near-ambient temperature. Any suitable adsorbent material may be used. In examples, the PSA of syngas purification system 234″ may include zeolites, for example 5A zeolite, activated carbon or other material suitable for the adsorption of methane or other hydrocarbons and/or other carbon species such as CO and CO2 that may be present in the hydrogen-rich ammonia syngas stream 230′. In examples, the syngas purification system 234″ may be configured to remove at least a portion of any methane gas or other hydrocarbons or carbon species that may be present in hydrogen-rich ammonia syngas stream 230′. In examples, the syngas purification system 234″ may be configured to remove all methane gas or other hydrocarbons or carbon species that may be present in hydrogen-rich ammonia syngas stream 230′.

In examples, the syngas purification system 234″ may include a discard stream 256″ including the removed methane gas or other hydrocarbons or carbon species from the hydrogen-rich ammonia syngas stream 230′. In examples, discard stream 256″ or a portion thereof may be directed to steam pre-reformer 244 to be used as fuel. In examples, discard stream 256″ may supplement and/or replace fuel stream 214 and/or the methane rich gas, or portion thereof, from the integrated steam cracking unit if used as fuel for the steam pre-reformer 244. In examples, if desired, the discard stream 256″ or a portion thereof may be directed to the cracking furnace of the integrated steam cracking unit to be used as fuel.

In examples, by inputting the nitrogen stream from the ASU 248 into the ammonia synthesis system 240 rather than at or just after the syngas purification system 234″, the blue ammonia unit 200″ may yield a purified ammonia syngas stream 236″ that is free of nitrogen. In examples, purified ammonia syngas stream 236″ may include a hydrogen gas stream that is substantially hydrogen gas. In examples, the purified ammonia syngas stream 236″ may include a hydrogen concentration >99.5 mol %. In examples, the purified ammonia syngas stream 236″ may include a 100 mol % pure hydrogen stream.

In examples, one or more of the same fluid connections between a steam cracking unit and the blue ammonia unit may be implemented with blue ammonia unit 200″ as those previously described with reference to blue ammonia unit 200′. In examples, at least a portion of the methane-rich gas stream from the integrated steam cracking unit may be directed to a steam pre-reformer 244 to be used as fuel and/or feed.

In examples, a hydrogen-rich stream from the integrated steam cracking unit may be supplemented by at least a portion of hydrogen-rich ammonia syngas stream 230′. In examples, a hydrogen-rich stream from the integrated steam cracking unit may be supplemented by at least a portion of purified ammonia syngas stream 236″. In examples, at least a portion of the hydrogen-rich stream form the integrated steam cracking unit may be combined with hydrogen-rich ammonia syngas stream 230′ prior to the syngas purification system 234″. In examples, all of the hydrogen-rich stream from the integrated steam cracking unit may be combined with hydrogen-rich ammonia syngas stream 230′ prior to the syngas purification system 234″. In examples, a portion of the purified ammonia syngas stream 236″ may be the only hydrogen gas containing stream directed to a cracking furnace of the integrated steam cracking unit to be used as fuel. In examples, a portion of the purified ammonia syngas stream 236″ may replace the hydrogen-rich stream from the steam cracking unit in the fuel supply to the cracking furnace of the integrated steam cracking unit.

In examples, a portion 238b″ of purified ammonia syngas stream 236″ may be used as fuel for the pre-reformer 244. In examples, a portion 238b″ of purified ammonia syngas stream 236″ may be combined with and/or used in place of fuel 214. In examples, portion 238b″ of purified ammonia syngas stream 236″ may be combined with at least a portion of the methane-rich gas from the integrated steam cracking unit to be used as fuel to supplement and/or substitute fuel 214. In examples, portion 238b″ of purified ammonia syngas stream 236″ may be used to supplement and/or substitute fuel 214 in place of and/or together with portion 232b″ of hydrogen-rich ammonia syngas stream 230″. In examples, the portion 238b″ of purified ammonia syngas stream 236″ may have lower to not hydrocarbon or methane content thus reducing and/or eliminating carbon emission when used a fuel for the pre-reformer 244.

In examples, the integrated system and process as described herein may be configured to affect the hydrogen concentration of the fuel feed to the cracking furnace by controlling and/or adjusting the supplementation of the hydrogen-rich stream of the hydrogen gas containing stream directed to the cracking furnace of the integrated steam cracking unit to be used as fuel as described earlier with reference to FIG. 2B.

### Steam Cracking Technology

In examples, the process and system as described include fluidly connecting a steam cracking unit to the blue ammonia unit as previously described. Different types of steam cracking units may be implemented in the integration process and system.

In examples, a steam cracking unit 110 may include a cracking furnace 112 as cracking furnace 300 having a gas feed as, for example, shown in FIG. 3A. In examples, the cracking furnace 300 may include a radiant section 302 and a convection section 304. A source of combustion air 306 may be used together with a fuel gas 308 as a combustion mixture for the radiant section 302 of the furnace. In examples, the combustion air may be pre-heated. In examples, the pre-heating of the combustion air may be accomplished using a heater 310 that recovers heat from a flue gas in the convection section 304 of the cracking furnace 300. In examples, a hydrocarbon gas feed 312 may be fed to one or more reaction tubes 314 provided in the radiant section 302 of the cracking furnace 300. In examples, the feed 312 may be preheated prior to feeding it to the one or more reaction tubes 314. In examples, the feed 312 may be pre-heated via a heater 316 that recovers heat from the convection section of the furnace, via a feed/effluent heat exchanger 318 that transfers heat from an effluent cracked gas to the feed 312, or a combination thereof. In examples, the cracking reaction may occur in one or more reaction tubes 314. In examples, the cracking reaction may produce an effluent cracked gas. In examples, the effluent cracked gas may contain methane, hydrogen, and one or more olefins. In examples, the effluent cracked gas may be cooled by one or more quenchers 320. In examples, the fuel gas 308 may include a hydrogen-rich gas stream or a high purity hydrogen gas stream.

In examples, as illustrated in FIG. 3B, the steam cracking unit 110 may include a cracking furnace 112 as cracking furnace 350 with liquid feed. As illustrated in FIG. 3B, the cracking furnace 350 of the steam cracking unit may include a liquid naphtha feed (LN Feed) 352. In examples, as shown, the liquid feed 352 may be pre-heated prior to entering one or more reaction tubes 354 in the radiant section 356 of the cracking furnace 350. In examples, one or more heater 358 may be used to preheat the feed to vaporize the feed prior to injection into the one or more reaction tubes 354. In examples, the one or more heaters 358 may be configured to recover flue gas heat from convection section 366 of the cracking furnace. In examples, a fuel gas 360 and combustion air 362 may be fed to the radiant section 356 of cracking furnace 350 for combustion and heat generation. One or more quenchers 364 may be used to quench an effluent cracked gas of cracking furnace 350.

In examples, the steam cracking unit 110 may include a recovery system 114 in which effluent cracked gas may be processed to further segregate the methane, olefins, and hydrogen. In examples, the process may yield a hydrogen-rich gas stream, an olefins stream, and a methane-rich gas stream.

In examples, the cracking furnace design may include one or more burners in capable of burning 100% pure hydrogen.

In examples, the cracking furnace may use high purity hydrogen as fuel gas to achieve net zero CO2 emission from the furnaces. In examples, high purity hydrogen may be the only fuel gas other than combustion air. In examples, the combustion air is free or substantially free (i.e. no more than negligible amount or 1 mol % or less) of hydrocarbons.

In examples, the cracking furnace design may use one or more of features to provide the most capital and energy-efficient solution to achieve the lowest overall carbon emission.

In examples, the combustion air may be preheated to minimize the furnace fired duty and associated import hydrogen required. In examples, the feed to the cracking furnace may be preheated. In examples, both the combustion air and the feed may be preheated. In examples, the combustion air may be preheated by recovering heat from the convection section of the cracking furnace, by heat exchanger, one or more electronic heaters, or any combination thereof. In examples, the hydrocarbon feed to the cracking furnace may be preheated via one or more heat exchangers, against the cracking furnace effluent gas, by recovering heat from the convection section of the cracking furnace, by one or more electric heaters, or any combination thereof. In examples, a liquid naphtha feed may be heated to produce a gas feed prior to entering the one or more reactor tubes of the cracking furnace.

In examples, the combustion air may be preheated to a temperature of about 400° C. to about 450° C. or to about 650° C. to about 750° C. In examples, the hydrocarbon feed stream to the cracking furnace may be preheated to about 620° C. to about 640° C. prior to introducing it into the one or more reactor tubes of the cracking furnace.

In examples, the cracking furnace 112 may be configured to apply a combustion air preheat design as for example disclosed in co-pending U.S. application Ser. No. 17/880,973, filed on Aug. 4, 2022, entitled “Low CO2 emission Ethane Cracker”, which is incorporated herein by reference in its entirety. In examples, the cracking furnace may be configured to preheat combustion air as for example described in co-pending U.S. Application No. 63/516,104, filed on Jul. 27, 2023, entitled “Net Zero Ethane Cracker with no External Hydrogen Import”, incorporated herein by reference in its entirety. In examples, the cracking furnace may be configured to preheat the hydrocarbon feed and/or combustion air as for example described in co-pending U.S. Application No. 63/516,066, filed on Jul. 27, 2023, entitled “100% Hydrogen-Fired Liquid Cracking Furnace”, incorporated herein by reference in its entirety.

As illustrated in FIG. 4 and, for example, as discussed in co-pending U.S. application Ser. No. 17/880,973, the steam cracking unit may include a recovery system 114 as recovery system 400 to recover a methane-rich gas stream, a hydrogen-rich gas stream, and an olefins stream.

FIG. 4 illustrates an example of recovery system 400. Other recovery system designs may also be employed.

In examples, system 400 may be implemented for an ethane cracking process. The cracked gas process stream from the cracking furnace may include hydrogen, methane, and ethylene. In examples, the cracked gas process stream may enter the illustrated process, for example, at a temperature of about −73° C. The temperatures and pressures in this description of recovery system 400 are only illustrative of a particular embodiment of the process. In examples, the temperatures/pressures may be varied. The cracked gas process stream may be cooled in the cold box 408. In examples, cold box 408 may include other hot and cold lines not illustrated here.

In examples, a light fraction of the cracked gas process stream from cracking furnace 112 may be progressively cooled and passed through knock-out drums 402 and 404 to separate out ethylene. In examples, the light fraction of the cracked gas process stream from cracking furnace 112 may include hydrogen, methane, carbon monoxide, ethylene, ethane, or any combination thereof. The cooling temperatures can be configured to manage the approach temperatures in the cold box. According to some embodiments, the temperature of the first knock-out drum 402 may be about −115° C.±10° C. and the temperature of the second knock-out drum may be about −130 to about −145° C. The bottom streams of the knock-out drums 402 and 404, which are enriched in ethylene, can be combined into an ethylene-rich stream 406. The ethylene-rich stream 406 can be recompressed using a turbo expander/compressor 410 to provide an ethylene-rich ethylene recovery stream 412.

In examples, the top streams of the knock-out drums 402 and 404, which are enriched in methane and hydrogen can be further cooled in the cold box and provided to a third knock-out drum 414. In examples, the temperature of the third knock-out drum 414 may be about −163° C.±10° C. The top stream 416 from the third knock-out drum 414 is enriched in hydrogen. The bottom stream 418 from the third knock-out drum 414 is enriched in methane. The temperature of the third knock-out drum 414 may determine how much methane is knocked out, i.e., it can determine the purity of the hydrogen stream.

In examples, the methane-enriched bottom stream 418 may be reheated in the cold box and then exits the system as a methane-rich gas stream 420.

The hydrogen-enriched top stream 416 may be reheated in the cold box to provide a reheated hydrogen-enriched stream 422. In examples, the temperature of the reheated hydrogen-enriched stream 422 can be about −140° C. and its pressure can be about 20 to about 45 barg.

In examples, where the hydrogen-rich gas stream ultimately output from recovery system 114 or 400 is to be used as fuel for the cracking furnace of the steam cracking unit from where the hydrogen gas is being recovered, the hydrogen-enriched stream 422 may be expanded using the turbo expander/compressor 410 to yield an expanded hydrogen-enriched stream 424. In examples, the expansion may lead to a drop in the temperature and pressure of the expanded hydrogen-enriched stream 424. For example, post expansion, the temperature of hydrogen-enriched stream 424 may be about −177° C. and the pressure may be less than about 10 barg, for example about 6 barg. In examples, the expanded hydrogen-enriched stream 424 may be reintroduced to the cold box 408, thereby providing a cold stream within the cold box capable of providing an adequate temperature approach to effect the separation of methane and hydrogen in the knock-out drum 414. The expanded hydrogen-enriched stream 424 may ultimately exit the cold box as hydrogen-rich gas stream 426.

In examples, where the hydrogen-rich gas stream ultimately output from recovery system 114 or 400 is to be directed to the blue ammonia unit 130 for further purification, then the hydrogen enriched top stream 416 from drum 414 may be kept at pressure. In examples, the hydrogen enriched top stream 416 may just be reheated and sent to the blue ammonia unit 130 to be combine with effluent stream 134 ahead of syngas purification system 234, 234′, or 234″. In examples, no expansion of the hydrogen enriched top stream 416 would be performed. To still provide a stream cold enough to provide cooling needed in the coldest section of the cold box to achieve the target conditions in drum 414, in examples, prior to directing the hydrogen enriched top stream 416 to the blue ammonia unit 130, a portion, for example about 10-15%, of the hydrogen enriched top stream 416 may be split off and mixed with methane-enriched bottom stream 418 before being reheated in the cold box. In this manner, it may be possible to lower the vaporization temperature of the methane-enriched bottom stream 418 and thus enabling it to provide the desired temperature approach.

In examples, the hydrogen-rich gas stream 426 may comprise greater than 90 mol % hydrogen, or greater than 95 mol % hydrogen, with most of the remainder comprising methane. In examples, the system 400 may recover over 90% or over 95% of the hydrogen available in the cracked gas process stream.

As described earlier various integration options may be implemented in the integration of a steam cracking unit 110 and a blue ammonia unit 130.

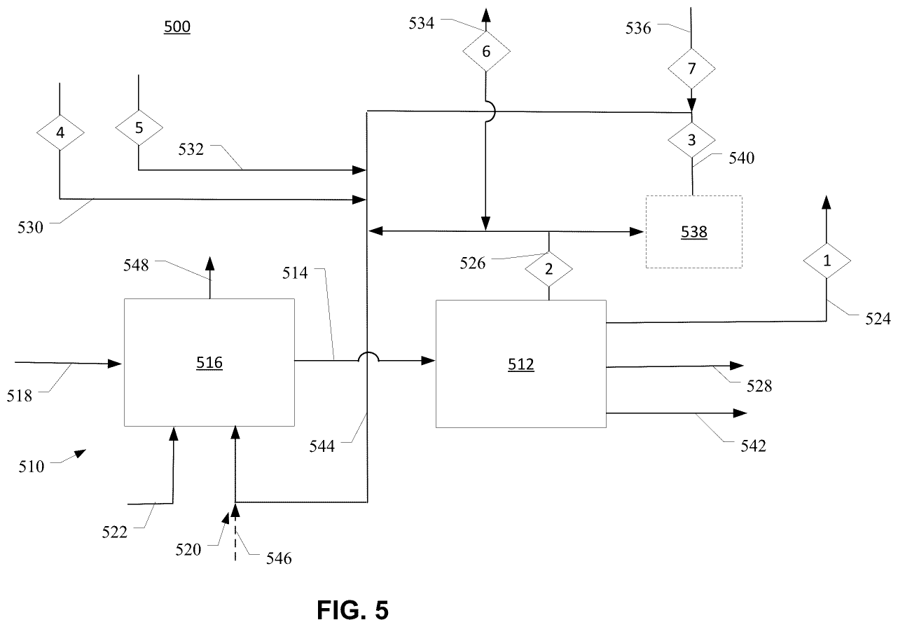

FIG. 5 illustrates examples of the various integration options between the steam cracking unit 110 and blue ammonia unit 130. In examples, one or more lines, pipes and/or conduits may be used to fluidly connect the steam cracking unit 110 to the blue ammonia unit 130. In examples, one or more valves, not shown, may be included to control the flow through the one or more lines, pipes and/or conduits. In examples, the one or more lines, pipes and/or conduits may be used to direct and/or transfer one or more streams (feeds/effluents) between the steam cracking unit and the blue ammonia unit.

In examples, as illustrated in FIG. 5, the integration system and process 500 of a steam cracking unit 510 and of a blue ammonia unit (not shown) may include one or more of the following features.

In examples, the integration may include the implementation of a separation process through a recovery system 512 of the effluent cracked gas 514 from reaction tubes of a cracking furnace 516. In examples, cracking furnace 516 may receive a hydrocarbon feed 518. In examples, cracking furnace 516 may include a steam feed (not shown). In examples, heat may be generated in cracking furnace 516 by burning a fuel 520 mixed with a combustion air 522.

In examples, the recovery system 512 may be configured to segregate a methane-rich gas stream 524 (stream 1) and a hydrogen gas containing stream such as a hydrogen-rich gas stream 526 (e.g., 90-95 mol % purity) gas (stream 2). In examples, the recovery system 512 may also include an effluent olefin stream 528 and optionally a by-product effluent stream 542.

In examples, the hydrogen-rich gas stream 526 may be produced from the recovery of internally-produced hydrogen, i.e. hydrogen produced in the cracking furnace 516 during the cracking process of one or more hydrocarbons contained in the hydrocarbon feed 518. In examples, the recovery may be accomplished as for example described with reference to FIG. 4. In examples, the hydrogen concentration of the hydrogen-rich stream 526 may be maximized.

In examples, the integration process and system 500 may be configured to send at least a portion of methane-rich gas stream 524 from steam cracking unit 510 to the blue ammonia unit. As previously stated, the methane-rich gas stream 524 may be used in the blue ammonia unit as feed gas and/or as fuel gas. In examples, the methane-rich gas stream 524 may be used as feed and/or as fuel in the hydrogen generation system of the blue ammonia unit.

In examples, the integration process and system 500 may be configured to include an import of a hydrogen gas containing stream from the blue ammonia unit and/or from recovery system 512 to the cracking furnace 516 of the steam cracking unit 510 via a conduit or line 544 to be used as at least a part of the fuel gas in the cracking furnace 516. In examples, fuel 520 may be optionally supplemented by an outside source 546. In examples, the imported hydrogen gas containing stream may originate at least in part from hydrogen produced from the methane-rich gas stream 524 directed from the steam cracking unit 510 to the blue ammonia unit. In examples, the hydrogen produced from the methane-rich gas stream 524 may be produced in the hydrogen generation system of the blue ammonia unit.

In examples, the hydrogen gas containing stream may be drawn from the blue ammonia unit at one or more locations. In examples, hydrogen gas containing stream may be drawn at one or more of at least four potential locations.

In examples, where the blue ammonia unit is a Type 1 as, for example, illustrated in FIG. 2A, the draw of hydrogen gas containing stream may be a portion of the hydrogen-rich ammonia syngas stream 530 drawn from between CO2 separator and syngas purification system (stream 4). At this location hydrogen purity may be approximately 65 mol %, and the stream contains approximately 2 mol % of residual methane and CO. Use of this stream as fuel gas can lead to significant, but not complete decarbonization of the steam cracker.

In examples, the hydrogen gas containing stream may be a portion of the purified ammonia syngas stream 532 drawn in a Type 1 blue ammonia unit from downstream of syngas purification system (stream 5), where the hydrogen gas containing stream may be free of methane, hydrocarbons, and other carbon species, and may contains approximately 75 mol % hydrogen and 25 mol % nitrogen. In examples, use of this stream may provide the opportunity for a high degree or complete decarbonization of the steam cracker unit.

In examples, where the blue ammonia unit is a Type 2 as, for example, illustrated in FIG. 2B, the draw of hydrogen gas containing stream may be a portion of the hydrogen-rich ammonia syngas stream 534 from between CO2 separator and syngas purification system (stream 6). At this location hydrogen purity of the hydrogen gas containing stream may be approximately 96 mol %, with the balance containing approximately 4 mol % of residual methane, hydrocarbons and/or other carbon species. Use of this stream as fuel gas may lead to significant, but not complete decarbonization of the steam cracker unit.

In examples, the hydrogen gas containing stream may be a portion of the purified ammonia syngas stream 532 drawn in a Type 2 blue ammonia unit from downstream of syngas purification system (stream 5), where the hydrogen gas containing stream may be free of methane, hydrocarbons, and other carbon species, and may contains approximately 75 mol % hydrogen and 25 mol % nitrogen. In examples, use of this stream may provide the opportunity for a high degree or complete decarbonization of the steam cracker unit.

In examples, where the blue ammonia unit is a Type 3 as, for example, illustrated in FIG. 2C, the draw of hydrogen gas containing stream may be a portion of the hydrogen-rich ammonia syngas stream 534 from between CO2 separator and syngas purification system (stream 6). At this location hydrogen purity may be approximately 96 mol %, and the hydrogen gas containing stream may contain approximately 4 mol % of residual methane, hydrocarbons, or other carbon species. Use of this stream as fuel gas can lead to significant, but not complete decarbonization of the steam cracker.

In examples, the hydrogen gas containing stream may be a portion of the purified ammonia syngas stream 536 drawn in a Type 3 blue ammonia unit from downstream of the syngas purification system, for example the PSA, (stream 7) where the hydrogen gas containing stream may have a very high purity, i.e. >99.5 mol %, or be pure, i.e. 100 mol %, hydrogen gas. Use of this stream may provide the opportunity for complete decarbonization of the cracker.

In examples, the handling of internal hydrogen produced in the steam cracking unit may depend on the ammonia unit configuration.

In examples, through integration as described herein it may be possible to partially or fully decarbonize the cracking furnace 516 thus resulting in a flue gas stream 548 having a decreased amount or no CO2.

In examples, for partial decarbonization part or all of internally produced hydrogen gas containing stream (stream 2) such as hydrogen-rich gas stream 526 from the steam cracking unit can be used as fuel gas in cracking furnace, supplemented by one or more hydrogen gas containing streams 530, 532, 534, and 536 from the ammonia unit (streams 4, 5, 6 or 7)

In examples, to improve decarbonization or to achieve full decarbonization when employing a Type 1 or 2 blue ammonia unit as described previously, the process may include purifying the hydrogen-rich gas stream 526 from the steam cracking unit in a supplemental PSA unit 538. In examples, the hydrogen-rich gas stream 526 may be directed to the PSA unit 538 to produce a high purity hydrogen stream 540 (stream 3). In examples, the high purity hydrogen stream 540 may be combined with hydrogen gas containing streams that may be free of carbon such as hydrogen gas containing streams 532 or 536 from the blue ammonia unit (streams 5 or 7) as fuel gas to furnaces.

In examples, to improve decarbonization or to achieve full decarbonization when integrating a Type 3 blue ammonia unit as previously described the process may include exporting hydrogen gas containing streams 526 from the steam cracking unit to the blue ammonia unit (reverse stream 6), entering immediately upstream of the ammonia purification system, for the example the PSA unit, of the blue ammonia unit to avoid duplication of equipment, and return purified hydrogen gas containing stream from the ammonia unit PSA as a portion of purified ammonia syngas stream 536 (stream 7).

In examples, the furnace design of the cracking system may include the following elements to provide the most capital and energy-efficient solution to achieve the lowest overall carbon emission: a) be configured to apply a combustion air preheat design, preferably heating air to 425-450° C. to minimize the furnace fired duty and associated import hydrogen-rich stream required; b) include burners in the furnace capable of burning 100% pure hydrogen; and c) be configured to use (optionally only use) internally produced hydrogen-rich or high purity hydrogen gas plus imported hydrogen-rich gas as fuel in the cracking furnaces.

In examples, the process and system may include one or more of the following elements: a) selective use of electric drivers for major compressors in recovery section as necessary to achieve a neutral or net export steam balance for the combined cracker and blue ammonia unit. This requirement can vary based on the source of import hydrogen-rich gas; and b) use green imported power with no associated CO2 emissions.

In examples, one or more advantages may be obtained from the above disclosed system and method. Reduction of carbon emission has become a key factor in evaluating project or technology viability. In examples, the method and system described may provide an effective way to achieve low or net zero carbon emissions, with potential for significant environmental and economic benefits.

In examples, integration of a steam cracker with a blue ammonia unit as described may minimize combined unit capital cost by sharing equipment and providing a lower capex option compared to direct application of carbon capture on the olefins unit.

In examples, integration of a steam cracker with a blue ammonia unit as described may minimize combined unit capital cost with maximum utilization of internally produced hydrogen and maximum air preheat on the furnaces, which may minimize the net hydrogen required from the blue ammonia unit.

In examples, integration of a steam cracker with a blue ammonia unit as described may minimize net hydrogen required and thus potentially reduce the associated CO2 produced in blue ammonia unit that has to be captured and/or stored.

In examples, integration of a steam cracker with a blue ammonia unit as described may provide for an efficient integration of feed and product streams that may reduce the combined unit energy consumption.

In examples, integration may reduce the requirement for ammonia unit feed sulfur removal, since methane-rich gas from cracker may be sulfur-free.

In examples, the systems described herein may include one or more control systems, sensors, and other standard components that allows for the control and operation thereof.

In examples, although not shown, the systems described herein may include one or more sensors as generally employed in the art. In examples, sensors may be used to monitor the operation of the systems described. Non-limiting examples of one or more sensors may include temperature sensors, pressure sensors, flow meters, and other like sensors.

In examples, although not shown, the one or more control systems may include one or more controllers and/or other suitable computing devices may be employed to control one or more of portions of systems described herein. Controllers may include one or more processors and memory communicatively coupled with each other. In the illustrated example, a memory may be used to store logic instructions to operate and/or control and/or monitor the operation of one or more described components. In examples, the controllers may include or be coupled to input/output devices such as monitors, keyboards, speakers, microphones, computer mouse and the like. In examples, the one or more controllers may also include one or more communication components such as transceivers or like structure to enable wired and/or wireless communication. In examples, this may allow for remote operation of one or more systems described herein.

In examples, memory associated with the one or more controllers and/or other suitable computing devices may be non-transitory computer-readable media. The memory may store an operating system and one or more software applications, instructions, programs, and/or data to implement the methods described herein and the functions attributed to the various systems. In various implementations, the memory may be implemented using any suitable memory technology, such as static random-access memory (SRAM), synchronous dynamic RAM (SDRAM), nonvolatile/Flash-type memory, or any other type of memory capable of storing information. The controls systems may include any number of logical, programmatic, and physical components.

Logic instructions may include one or more software modules and/or other sufficient information for autonomous operation, safety procedures, and routine maintenance processes. Any operation of the described system may be implemented in hardware, software, or a combination thereof. In the context of software, operations represent computer-executable instructions stored on one or more computer-readable storage media that, when executed by one or more processors, perform the recited operations. Generally, computer-executable instructions include routines, programs, objects, components, data structures, and the like that perform one or more functions or implement particular abstract data types.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A system comprising:
a steam cracking unit comprising a cracking furnace;
a blue ammonia unit in fluid communication with the steam cracking unit, the blue ammonia unit configured to generate a hydrogen gas containing stream;
a first conduit configured to direct the hydrogen gas containing stream to the steam cracking unit to be used as fuel.

2. The system of claim 1, the blue ammonia unit further comprising a hydrogen generation system configured to generate a hydrogen-rich ammonia syngas stream, wherein the hydrogen gas containing stream comprises the hydrogen-rich ammonia syngas stream.

3. The system of claim 1, the blue ammonia unit further comprising an ammonia syngas purification system configured to generate a purified ammonia syngas stream, wherein the hydrogen gas containing stream comprises the purified ammonia syngas stream.

4. The system of claim 1, the steam cracking unit further comprising a recovery system configured to receive an effluent cracked gas from the cracking furnace and separate from the effluent cracked gas at least a hydrogen-rich gas stream and a methane-rich gas stream.

5. The system of claim 4, further comprising a second conduit configured to direct the methane-rich gas stream from the steam cracking unit to the blue ammonia unit to be used as fuel, feed, or both.

6. The system of claim 5, further comprising a gas compressor configured to pressurize at least a portion of the methane-rich gas stream prior to reaching the blue ammonia unit.

7. The system of claim 6, further comprising a gas expander configured to expand the hydrogen gas containing stream prior to reaching the steam cracking unit.

8. The system of claim 7, wherein the gas compressor is powered by energy recovered by the gas expander.

9. The system of claim 7, further comprising a heater configured to heat the hydrogen gas containing stream prior to reaching the gas expander.

10. The system of claim 4, the steam cracking unit further comprising a recycle line configured to direct the hydrogen-rich gas stream from the recovery system to the cracking furnace to be used as fuel.

11. The system of claim 10, wherein:
the blue ammonia unit further comprising a hydrogen generation system configured to generate a hydrogen-rich ammonia syngas stream, wherein the hydrogen gas containing stream comprises the hydrogen-rich ammonia syngas stream; and
a fourth conduit configured to direct at least a portion of the hydrogen-rich ammonia syngas stream to the steam cracking unit for combination with the hydrogen-rich gas stream.

12. The system of claim 10, wherein:
the blue ammonia unit further comprising an ammonia syngas purification system configured to generate a purified ammonia syngas stream, wherein the hydrogen gas containing stream comprises the purified ammonia syngas stream; and
a fourth conduit configured to direct at least a portion of the purified ammonia syngas stream to the steam cracking unit for combination with the hydrogen-rich gas stream.

13. The system of claim 4, further comprising a third conduit configured to direct at least a portion of the hydrogen-rich gas stream from the steam cracking unit to the blue ammonia unit.

14. The system of claim 13, wherein the blue ammonia unit comprises an ammonia syngas purification system, and wherein the whole hydrogen-rich gas stream is directed to the ammonia syngas purification system.

15. The system of claim 14, further comprising a fourth conduit configured to direct an effluent purified ammonia syngas from the ammonia syngas purification system to the cracking furnace of the steam cracking unit to be used as fuel.

16. A process comprising:
generating a hydrogen gas containing stream in a blue ammonia unit; and
directed the hydrogen gas containing stream to a steam cracking unit as fuel.

17. The process of claim 16, further comprising:
recovering a methane-rich gas stream in the steam cracking process; and
directing the methane-rich gas stream to the blue ammonia unit as feed, fuel, or both.

18. The process of claim 16, further comprising recovering a hydrogen-rich gas stream from effluent cracked gas of a cracking furnace of the steam cracking unit.

19. The process of claim 18, further comprising directing the recovered hydrogen-rich to a cracking furnace of the steam cracking unit to be used as fuel.

20. The process of claim 19, further comprising supplementing the hydrogen-rich gas stream with a hydrogen gas containing stream from the blue ammonia unit.

21. The process of claim 20, wherein the hydrogen gas containing stream comprises at least a portion of a hydrogen-rich ammonia syngas stream generated from a hydrogen generation system of the blue ammonia unit.

22. The process of claim 21, wherein the hydrogen gas containing stream comprises at least a portion of a purified ammonia syngas stream generated by an ammonia syngas purification system of the blue ammonia unit.

23. The process of claim 18, further comprising directing the hydrogen-rich gas stream to a purification stage of the blue ammonia unit and directing at least a portion of a purified ammonia syngas stream generated by the ammonia syngas purification system to a cracking furnace of the steam cracking unit to be used as fuel.

24. The process of claim 17, further comprising:
compressing via a gas compressor at least a portion of the methane-rich gas stream directed to the blue ammonia unit prior to reaching the blue ammonia unit;
expanding via a gas expander the hydrogen gas containing stream generated in the blue ammonia unit prior to reaching the steam cracking unit; and
powering the gas compressor with an energy recovered from the gas expander.
